(19) United States
(12) Patent Application Publication
(10) Pub. No.: US 2001/0001406 A1
(43) Pub. Date: May 24, 2001

(54) METHOD OF MAKING TRANSMISSION LINES AND BURIED PASSIVE COMPONENTS IN GREEN TAPE

(76) Inventors: MICHAEL JAMES LIBERATORE, LAWRENCEVILLE, NJ (US); BARRY JAY THALER, LAWRENCEVILLE, NJ (US); PAUL F. PELKA, STANHOPE, NJ (US); EDWARD J. CONLON, PRINCETON, NJ (US); JON SHELDON PROKOP, DALLAS, TX (US)

Correspondence Address: WILLIAM J BURKE, SARNOFF CORPORATION PATENT OPERATIONS, CN 5300, PRINCETON, NJ, 085435300

(21) Appl. No.: 09/183,479

(22) Filed: Oct. 30, 1998

Related U.S. Application Data
(60) Provisional application No. 60/074,928, filed on Feb. 17, 1998.

(51) Int. Cl. C03B 29/00; C04B 33/34; C04B 37/00; B05D 5/12

(52) U.S. Cl. 156/89.12; 156/89.21; 427/96

(57) ABSTRACT

A method of making transmission lines and buried passive components in a green tape comprising embossing a channel or opening into the green tape of the desired size under heat and pressure, screen printing an ink of a conductive material or a passive component material to fill said embossed channel or opening; and firing said green tape. The embossing tool forms channels and openings having improved dimensional control over that obtained using screen printing. Further, embossing provides improved thickness control of lines and passive components as well.

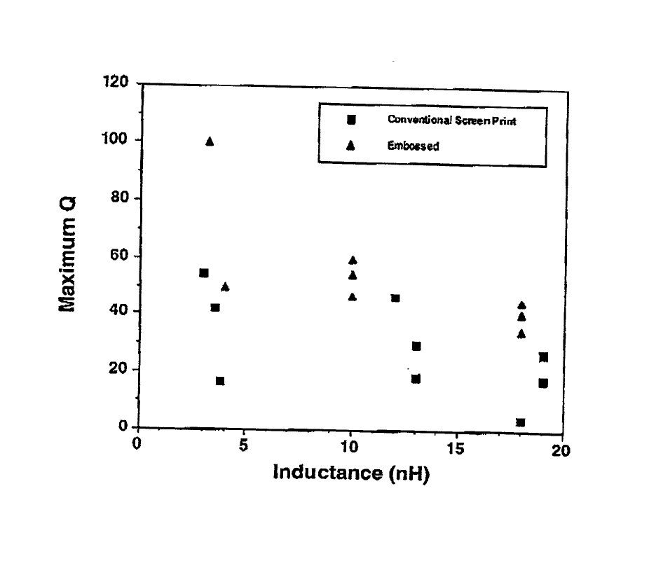

This application claims the benefit of U.S. Provisional Application Serial No. 60/074,928 filed Feb. 17, 1998.

The U.S. Government may have certain rights to the subject matter of this invention under Contract No. F33615-96-2-5105.

This invention relates to a method of making electronic packaging. More particularly, this invention relates to a method of making electronic packaging including embedded devices.

### BACKGROUND OF THE INVENTION

Electronic packaging, e.g., printed circuit boards, that includes circuitry, coupled and uncoupled transmission lines, and/or various buried passive components, such as capacitors, resistors, inductors and the like, are known. Such printed circuit boards are made by casting a glass or glass and ceramic powder mixture, together with an organic binder, to form what is commonly known as green tape. A conductive metal circuit or transmission line can be patterned onto the green tape surface by screen printing a conductor ink through a mask. A conductor ink is made from a mixture of a glass, generally the same glass as is used to make the green tape, and a conductive powder, mixed with a suitable organic vehicle. When a plurality of green tapes having circuitry printed thereon are to be stacked together, vias or openings are formed in each green tape that are aligned with a printed circuit on an adjacent green tape which are also filled with conductive materials, called via inks, that connect the circuits of the various layers electrically. Via inks are also made from a mixture of a glass, a conductive material and a suitable organic vehicle. Buried passive components such as capacitors, resistors and inductors can also be screen printed onto green tape layers using suitable dielectric inks.

The green tape layers are then stacked and aligned, laminated together under heat and pressure, and then fired to burn off the organic residues of the binder and the organic vehicle, and to sinter or densify the glass. The resultant screen printed lines and components can vary considerably in length, width and thickness however due to loss of line definition during the lamination process, and to the limited control over the components obtainable during the screen printing process. In making transmission lines, for example, poor line definition leads to high insertion and reflection losses.

Recently, devitrifying glasses have been used to form the green tapes, particularly those that can be fired at low temperatures of 1000° C. or less. These glasses can be used with lower melting, more conductive metals, such as silver, gold and copper, for making printed circuits.

Even more recently, the low firing temperature green tapes have been adhered to metal support substrates to increase the overall strength of the fired green tape stack. U.S. Pat. No. 5,277,724 to Prabhu describes these boards and bonding glasses that adhere the green tapes to the metal support board. These bonding glasses have an additional advantage in that, if chosen correctly, the shrinkage of the green tape with respect to the support substrate in at least the two lateral, x and y, dimensions, is greatly reduced. Thus the shrinkage that occurs during firing occurs mainly in the z, or thickness, dimension, and less distortion of the circuitry occurs. This also reduces problems of alignment of the circuit patterns in the glass layers and alignment of the circuit patterns to the via holes. Active devices can be placed into cavities punched into the green tapes that better retain their dimensions during firing as well.

Printed circuits operating at microwave frequencies are also known. Transmission line loss is caused by two factors; line resistance losses and line definition degradation. As microwave frequencies increase, line definition becomes the dominant factor for circuits operating at X-band frequencies (8.4 to 12.44 GHz) and higher.

Transmission lines conventionally are made on ceramic green tapes by screen printing an ink made of a suitable glass, a conductor and an organic vehicle. Conventionally, green tapes having circuits and transmission lines screen printed thereon are stacked, aligned and laminated together under heat and pressure prior to firing. During this lamination process, the conductor lines are flattened and even distorted. The conductor lines develop a tapered cross section and loss of some of their line definition. This is more pronounced for thicker conductor circuits. However, thicker circuits are desirable because they are more conductive and their resistance is lower. The thick film conductors become flattened more than thin film conductors and thus exhibit more insertion loss than their thin film counterparts. All circuit and transmiss1ion lines suffer from width variations and length variations; and embedded components also suffer from thickness variations during the lamination and firing steps caused by poor controls of the screen printing steps. The poor line definition leads to insertion and reflection losses and low Q values as well.

Thick film transmission lines having good line definition can be made using photolithographic techniques to form the lines. A coating of photoresist is deposited on a green tape and exposed to a suitable mask and developed to open a line pattern in the photoresist pattern on the green tape. This line can then be filled with a conductor ink. However, these lines require more steps than screen printing and thus are more expensive to make.

The features of surface and embedded components that result in sub-standard performance and poor repeatability are thickness and width variations and length variations. Buried capacitors, resistors and inductors vary from their specified values because of these variations, again caused by poor control using conventional screen printing.

Thus an inexpensive way to make transmission lines and passive components having improved line and feature definition on ceramic printed circuit boards would be highly desirable.

### SUMMARY OF THE INVENTION

In accordance with the invention, improved line definition for transmission lines and reduced variations in thickness, width and length of openings for forming buried passive components on printed circuit boards are made by embossing desired channels and openings in the green tapes using an embossing tool. These channels and openings are then filled, as by screen printing, with a suitable conductor, resistor, dielectric or metal ink to form transmission lines and buried passive components that do not distort or flatten during lamination of a green tape stack. Embossed transmission lines are made so that the conductive lines do not extend above the surface of the green tape. The channels can also be made so as to provide thicker conductor lines than can be obtained by screen printing alone, thereby improving the performance of circuits at microwave frequencies. The increased thickness of the conductive lines lowers the resistance of the conductors, allowing the lines to operate at higher frequencies with reduced transmission line loss. Embossing openings for buried passive components and then screen printing with a suitable ink composition tightens width, depth and length tolerances compared to the use of screen printing alone. Thus performance and repeatability are improved.

### IN THE DRAWING

The FIGURE is a graph of maximum calculated Q values versus inductance for prior art screen printed and embossed inductor coils of the present invention of varying size.

### DETAILED DESCRIPTION OF THE INVENTION

A system and materials have been developed for low temperature firing ceramics that can be used with low melt temperature materials such as silver. Green tapes made of one or more glasses and an organic binder are formed, and circuits screen printed thereon, using standard screen printing techniques. In order to form transmission lines and buried passive components without distortion during the firing step however, a combination of embossing and screen printing is used. In accordance with the present invention, prior to screen printing a circuit or passive buried component, a suitable pattern, e.g., a channel or depression of the desired size and shape, is made in the green tape using an embossing tool.

A suitable embossing tool having a desired pattern is made using photolithographic techniques. Use of an embossing tool provides improved accuracy and alignment of the transmission lines and/or cavities to be filled with conductive or dielectric material, as required.

An embossing tool can be made as follows. A photomask is prepared that has the pattern of the component opening or circuitry to be made, as well as registration dots. A brass plate is polished to optical flatness and copper is electroplated thereover to a thickness of several microns, either by electrolytic or electroless plating, in known manner. Registration dots aligned with those on the photomask are also scribed thereon. The pattern can be a line, or a shaped opening, including via holes and cavities for placement of electronic components. A photoresist layer is applied to the polished brass plate; the photomask is used to pattern the photoresist on the brass plate, and is developed so as to leave the areas to be plated exposed. The resist is patterned to a thickness greater than the planned metal plating thickness. Nickel or some other hard metal is then electroplated to the desired thickness through the openings in the developed photoresist, and the photoresist is stripped. The plated pattern can be optionally polished to improve the surface finish on the raised features of the embossing tool.

After preparing a green tape stack, the green tapes are embossed with the embossing tool using a heated lamination press at temperatures of from 115 to about 200° F., the highest temperature that will prevent the tape from adhering to the embossing tool. The depth of the embossed features should be that of the raised pattern on the embossing tool. The embossing tool can also be sprayed with a mold release agent.

After aligning the embossing tool and the green tape, a layer of polyethylene terephthalate sheet is applied to the green tape and the resultant assembly is placed between two copper plates in a laminating press. The copper plates may be treated with a silicon release agent. The resultant assembly of the silicon treated copper plate, green tape and mold release coated embossing tool is aligned and preheated for 30 seconds to two minutes at the embossing temperature. A pressure of from about 1200 to 2400 psi is applied to replicate the pattern of the embossing tool into the tape. Suitably the pressure is applied for a total of two minutes, releasing the pressure and rotating the assembly by 90 degrees at 30 second intervals.

After embossing, the assembly is cooled, and the embossing tape is removed from the embossing tool. The tool is sprayed with a solvent, e.g., isopropyl alcohol, prior to re-use.

The embossed lines and cavities in the green tape are then filled with a suitable ink by screen printing. Since the area to be filled is recessed, more than one pass and high screen printing pressures may be required to fill the lines and cavities. Since the inks are maintained by the walls of the channels and cavities embossed into the green tape, the inks do not have to be as viscous as when using screen printing alone. Thus inks can be used which have a high solids content, but lower viscosity than conventional inks. Channels for circuit lines can be embossed to a very precise thickness range of 25-50 microns, with an accuracy of ±1-2 microns. Screen printing on the other hand is only accurate to within ±2-3 microns, and large area capacitors only to ±5 microns.

To illustrate the inks useful in the invention, top conductor inks and buried conductor inks were prepared. The conductors used were silver flake #15 and SPQ silver powder available from the Degussa Corporation; a copper powder, Metz #10, also available from Degussa Corporation; an Asahi panel glass from Corning, Inc; an ethyl cellulose binder N 14 (molecular weight 14) and an ethyl cellulose N300 (molecular weight 300) available from Aqualon Corporation; and a solvent mixture of 60 weight percent of butyl carbitol and 40 weight percent of dodecanol. An equal parts mixture of lecithin and terpineol was also added.

The composition of three buried conductor embossing inks useful in the present invention and compared to a conventional buried conductor ink are summarized in the following Table I in weight percent.

TABLE I

| | Standard | Embossing Inks | | |
|---|---|---|---|---|
| Component | Ink | A | B | C |
| Silver flake | 82.4 | 82.4 | 16.1 | — |
| Silver powder | — | — | 64.6 | 72.1 |
| Resin VC108* | 16.5 | 5.5 | 5.4 | 21.9 |
| Resin VC110** | — | 11.0 | 10.0 | 3.7 |
| Hypermer PS2 | — | — | 1.6 | 2.3 |
| N-butyl phthalate | — | — | 0.7 | — |
| 50:50 mixture of | | | | |
| Lecithin/terpineol | 1.1 | 1.1 | 1.6 | — |
| Ink Viscosity | 45 | — | 30 | — |
| (poise @ 100 rad/s | | | | |

*Resin solution of 7.5% ethyl cellulose (MW14), 3.8% ethyl cellulose (MW300), 35.5% dodecanol, 53.2% butyl carbitol
**Resin solution of 3.4% ethyl cellulose (MW14) 38.7% dodecanol, 57.9% butyl carbitol

The present inks contain more lower viscosity resin solutions and larger amounts of finely divided silver powder, which improves the flow of these inks into vias and cavities. In general, when vias and cavities have smaller line widths or spacing, the more finely divided powdered silver is used in place of the larger particle size silver flake.

Table II summarizes top conductor ink compositions of the invention and provides a comparison with a conventional top conductor ink.

TABLE II

| | | |
|---|---|---|
| Top | Standard | Embossing Inks |

| conductor Ink | Ink | A | B |
|---|---|---|---|
| Silver flake | 32.5 | 32.6 | — |
| Silver Powder | 32.5 | 32.6 | 59.2 |
| Ceramic glass* | 5.7 | 5.7 | 6.3 |
| Panel glass** | 5.7 | 5.7 | 6.3 |
| Copper powder | 0.5 | 0.3 | 0.4 |
| Resin VC108 | 22.1 | 7.3 | 21.9 |
| Resin VC110 | — | 14.8 | 3.7 |
| Lecithin/terpineol | 1.0 | 1.0 | 2.3 |
| Ink Viscosity | | 25 | |

*45.43% ZnO, 11.38% alumina, 43.19% silica
**Asahi glass from Corning, Inc.

Resistor and capacitor inks are also made from similar glasses and organic vehicles, but instead of the active ingredient being a conductive powder, resistor powders including for example ruthenium oxide, were used to make resistors, and capacitors were made from dielectrics such as barium titanate and lead magnesium niobate.

The channels are inspected during manufacture to make certain the channels and cavities are completely filled. The embossed and screen printed green tapes are then aligned and stacked and fired in conventional manner to complete the package.

A series of inductors was made on green tapes TCE matched to gallium arsenide. The green tapes were supported on a metal support board of copper clad molybdenum. The metal core is bonded to the green tapes via a low melt temperature glass, e.g., a lead based glass.

Standard inductors were made by screen printing a thick film top conductor ink through a wire mesh screen, either 290 or 400 mesh, using a 1.0 mil emulsion.

The embossed inductors of the invention were made by embossing coils using an embossing tool and filling the openings using an embossing ink as described above.

All of the inductors were terminated with 50 ohm microstrips with ground pads on either side, which are connected to a ground plane with 8 mil diameter vias. This forms a ground signal-ground configuration compatible with Cascade microwave probes. The ground plane spacing was 20 mils (4 ceramic tape layers). Four green tapes 3″×3″ were laminated together using 3600 lb Of pressure, and co-laminated to a metal support at 800 lbs pressure.

Firing was done using a 4.5 hour cycle and a peak firing temperature of 915° C.

Insertion and reflection losses were measured using a HP network analyzer up to a frequency of 4 Ghz. Q values were calculated and plotted as a function of frequency. The FIGURE is a graph of maximum Q of three different sizes of inductor coils over frequency spectrum versus inductance.

It is apparent that for all sizes of inductor coils, the average embossed coils had a higher Q value than conventional screen printed inductor coils.

A series of filters were also fabricated on green tapes TCE matched to gallium arsenide. The green tapes were supported on a metal support board of copper clad molybdenum. The metal core is bonded to the green tapes via a low melt temperature glass, e.g., a lead based glass.

Standard filters were made by screen printing a thick film top conductor ink through a wire mesh screen, either 290 or 400 mesh, using a 1.0 mil emulsion.

The embossed filters of the invention were made by embossing a series of coupled transmission lines using an embossing tool and filling the openings using an embossing ink as described above. The line width and spacings are such that the filter performs at X-band frequencies (8.4-12.4 GHz).

Filter boards were cofired as 3 layer laminates with the filters on the surface. Lamination, colamination and cofiring were done using established procedures.

Insertion and reflection losses were measured for the filters at X-band frequencies and Q values calculated. Embossed filters showed roughly a 30% improvement in Q over non-embossed.

We claim:

1. A method of forming transmission lines and openings for buried passive components in green tapes comprising
embossing a channel or opening in a green tape using an embossing tool having a desired pattern thereon using heat and pressure sufficient to transfer the pattern from the embossing tool to the green tape, and
screen printing a suitable ink into the channels or openings to a desired thickness.

2. A method according to claim 1 wherein embossed transmission line channels are filled with a conductive ink.

3. A method according to claim 2 wherein the conductive ink includes silver powder and an organic vehicle to provide a viscosity of about 30 poise.

4. A method according to claim 1 wherein embossed openings are made in a green tape and screen printed to fill the opening using a resistor ink.

5. A method according to claim 1 wherein embossed openings are made in a green tape and screen printed to fill the opening using a capacitor ink.

6. A method according to claim 5 wherein said capacitor ink includes lead magnesium niobate.

7. A method according to claim 5 wherein said capacitor ink includes barium titanate.

8. A method according to claim 4 wherein said resistor ink includes ruthenium oxide.

9. A method of making buried passive components comprising
a) embossing an opening of a desired size in a green tape;
b) filling said opening by screen printing an ink including said component material;
c) burying said green tape in a green tape stack;
d) aligning and laminating said stack onto a support board coated with a low melt temperature glass; and
e) firing said stack to remove organic materials and to densify the glass of the green tape.

10. A method according to claim 9 wherein said support board is of metal.

11. A method according to claim 1 wherein a pattern of embossed openings are made in a green tape and screen printed to fill the pattern with a conductive ink to form inductors of high Q.

12. A method according to claim 1 where a pattern of embossed openings are made in a green tape and filled with conductive ink to form filters of high Q.
